(19) United States
(12) Patent Application Publication
(10) Pub. No.: US 2015/0100467 A1
(43) Pub. Date: Apr. 9, 2015

(54) ANALYZING TRANSACTION ITEM-IDENTIFYING DATA TO DETERMINE WHICH ITEMS IN THE TRANSACTION TO ASSIGN TO INDIVIDUALS OF A GROUP ASSOCIATED WITH THE TRANSACTION

(71) Applicant: Bank of America Corporation, Charlotte, NC (US)

(72) Inventors: Jason P. Blackhurst, Charlotte, NC (US); Laura C. Bondesen, Charlotte, NC (US); Matthew A. Calman, Charlotte, NC (US); Katherine Dintenfass, Charlotte, NC (US); Carrie Anne Hanson, Charlotte, NC (US)

(73) Assignee: Bank of America Corporation, Charlotte, NC (US)

(21) Appl. No.: 14/049,537

(22) Filed: Oct. 9, 2013

(51) Int. Cl. G06Q 40/00; G06Q 20/04

(52) U.S. Cl. CPC G06Q 40/12; G06Q 20/045
USPC 705/30

(57) ABSTRACT

Apparatus, methods, and computer program products are described for automatically determining which individual, from amongst a group of individuals, for example, a household, should be assigned which items in a transaction for the purpose of assessing budget for the group on a per-individual level. Transaction item-identifying data, such as an e-receipt is analyzed to identify items in a transaction, the transaction is determined to be associated an account that is tied to a group of individuals and the items in the transaction are determined to belong to or otherwise, for budgetary purposes, assignable to an individual belonging to the group.

### FIELD

In general, embodiments of the invention relate to methods, systems, apparatus and computer program products for finance management and, more particularly, for analyzing transaction item-identifying data, such as an e-receipt to determine which items in a transaction belong to or are otherwise assigned to an individual belonging to a group of individuals (e.g., a household, small business or the like) that is associated with the transaction.

### BACKGROUND

There has been recent growth in personal finance management applications, such as online banking, mobile banking and the like, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction date, but also to manage finances. A current drawback with online banking is that transactional level detail for a given purchase by the customer is limited. Despite the large amount of information sent by merchants to customers regarding purchases, merchants currently do not provide purchase details to financial institutions. The only information provided by the merchant to the financial institution is information about the merchant and an overall transaction amount. For example, if a financial institution customer purchases several clothing items from a merchant and uses a financial institution debit card, credit card or check, all that is provided to the financial institution is the merchant information and overall purchase amount. Product level detail that is present on the receipt provided to the customer by the merchant is not provided to the financial institution.

The lack of detailed information regarding a given transaction in the online or mobile banking environment limits a customer's ability to ascertain a larger picture of purchase history and financial transaction information. This is especially true in instances in which a group of individuals, such as members of a household or the like, attempt to determine what portion of the overall group budget should be accredited to individuals in the group. In the household scenario, an accurate depiction of the budget breakdown per household member cannot be obtained by merely assigning a transaction, for budgetary purposes, to the individual that conducted the transaction. This is because, certain individuals in the household, such as children, may not conduct transactions, yet specific items in a transaction, (e.g., clothes, entertainment, food or the like) may need to be accredited to them for budgetary purposes.

If all the online or mobile banking platform presents to the customer is conventional data regarding a transaction (i.e., merchant, date of purchase and total purchase amount), without providing item-level data (i.e., the specific items purchased and their corresponding amount), the customer is unable to ascertain what items in a transaction should be accredited to individuals in a group (e.g., members of the household) for budgetary purposes or the like. In such instances, if the customer desires to keep track of expenditures on an individual basis, the customer must retain receipts that identify items and manually enter such data into a budgeting tool.

Therefore, a need exists to be able to automatically determine a budget breakdown, at the item-level, for individuals or members of a group, such as members of a household, employees of a small business or the like.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for analyzing transaction item-identifying data, such as an e-receipt to identify items in a transaction, determine that the transaction is associated an account that is tied to a group of individuals, such as a household, a small business or the like, and then determine which items in the transaction belong to or should otherwise be assigned to an individual belonging to the group for budgetary purposes or the like. In this regard, embodiments of the present invention automatically, without the need for user/customer input/intervention, determine a budget breakdown, at the item-level, for individuals of a group, such as members of a household, employees of a small business or the like.

An apparatus for identifying which items in a transaction are associated with which individuals from a group defines first embodiments of the invention, The apparatus includes a computing platform having a memory and at least one processor in communication with the memory device. The apparatus further includes an aggregation and structuring application stored in the memory, executable by the processor and configured to (a) receive transaction item-identifying data, associated with transactions that include one or items, in an unstructured format, (b) structure the transaction item-identifying data for financial institution compatibility and (c) store the structured data in a first database. The apparatus further includes a group determination application stored in the memory, executable by the processor and configured to determine that one or more of the transactions are associated with a group of individuals. In addition the apparatus includes an item assignment determination application stored in the memory, executable by the processor and configured to (a) access the item-identifying data in the first database to determine an individual from the group of individuals to assign to one or more of the items in the transactions and (b) generate and store an item assignment indicator in a second database that indicates the individual in the group is assigned to a corresponding item.

In specific embodiments of the apparatus the item assignment determination application is further configured to match the item-identifying data in the first database to the item assignment-criteria stored in a third database to determine the individual from the group of individuals to assign to one or more of the items in the transaction. In such embodiments of the apparatus, the item-assignment criteria may be received in the third database by inputs provided from one or more individuals from the group (e.g., individual profiles set-up by members of the group). In other related embodiments the apparatus, may include an item-assignment criteria learning application stored in the memory, executable by the processor and configured to learn the item-assignment criteria based on previous item assignments and, subsequently, stored the learned item-assignment criteria in the third database.

In further embodiments the apparatus may include a financial management application stored in the memory, executable by the processor and configured to provide item-level filtering for individuals in the group, wherein the filtering is configured to provide a view of which items in the transactions are assigned to which individuals in the group. In such embodiments of the apparatus, the financial management application is further configured to provide for users to re-assign items that are identified by the users as having been incorrectly assigned to individuals by the item assignment determination application.

In further specific embodiments of the apparatus, the group determination application is further configured to match financial account data associated with the transaction to group data stored in a third database that associates financial accounts with groups.

Moreover, in additional specific embodiments of the apparatus, the aggregation and structuring application is further configured to receive e-receipts corresponding to a transaction, wherein the e-receipts include one or more unique identifiers each of which identify an item in a corresponding transaction. In such embodiments of the apparatus, the aggregation and structuring may be further configured to crawl an email accounts to identify and collect e-receipts.

A method for identifying which items in a transaction are associated with which individuals from a group defines second embodiments of the invention. The method includes receiving transaction item-identifying data, associated with transactions that include one or more items, in an unstructured format, and structuring the transaction item-identifying data for financial institution system compatibility. The method further includes determining that one or more of the transactions are associated with a group of individuals and determining an individual, from the group of individuals, to assign to one or more of the items in the transactions. In addition the method includes generating and storing an item assignment indicator that indicates the individual from the group is assigned to a corresponding item.

In specific embodiments of the method, determining the individual further includes matching the item-identifying data to item-assignment criteria stored in an item-assignment database to determine the individual from the group of individuals to assign to one or more of the items in the transaction. The item-assignment criteria indicates which items and types of items are to be assigned to which individuals in the group. In specific embodiments of the method, the item-assignment criteria is received at the item-assignment database by inputs from one or more individuals in the group (e.g., inputs into individual profiles set-up by members of the group). In other embodiments the method includes learning, by a computing device processor, the item-assignment criteria based on previous item assignments and storing the learned item-assignment criteria in the item-assignment database.

In further embodiments the method includes providing, within a network-accessible financial management application, item-level filtering for individuals in the group, wherein the filtering is configured to provide a view of which items in the transactions are assigned to which individuals in the group.

In other embodiments of the method, receiving the transaction item-identifying data further includes receiving e-receipts corresponding to a transaction, wherein the e-receipts include one or more unique identifiers each of which identify an item in the transaction. In such embodiments the method may further include crawling an email account to identify and collect e-receipts.

A computer program product that includes non-transitory computer-readable medium defines third embodiments of the invention. The computer-readable medium includes a first set of codes for causing a computer to receive transaction item-identifying data, associated with a transaction including one or more items, in an unstructured format. Additionally, the computer-readable medium includes a second set of codes for causing a computer to structure the transaction item-identifying data for financial institution system compatibility. In addition, the computer-readable medium includes a third set of codes for causing a computer to determine that one or more of the transactions are associated with a group of individuals and a fourth set of codes for causing a computer to determine an individual, from the group of individuals, to assign to one or more of the items in the transactions. Moreover, the computer-readable medium includes a fifth set of codes for causing a computer to generate and store in memory an item assignment indicator that indicates the individual from the group is assigned to a corresponding item.

Thus, as described in more detail below, embodiments of the present invention relate to systems, apparatus, methods, and computer program products for analyzing transaction item-identifying data, such as an e-receipt to identify items in a transaction, determine that the transaction is associated an account that is tied to a group of individuals, such as a household, a small business or the like, and then determine which items in the transaction belong to or should otherwise be assigned to an individual belonging to the group for budgetary purposes or the like. In this regard, embodiments of the present invention automatically, without the need for user/customer input/intervention, determine a budget breakdown, at the item-level, for individuals of a group, such as members of a household, employees of a small business or the like.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 is a schematic diagram representation of an operating environment for retrieval of electronic communications relating to customer purchase transactions, parsing of data within such electronic communications into structured data, formatting the data for financial institution accessibility and inclusion of such data into a network-accessible financial institution application, in accordance with embodiments of the present invention;

FIG. 2 is a block diagram of an apparatus for automatically determining which items in a transaction are associated with which individuals from a group of individuals, in accordance with embodiments of the present invention;

FIGS. 3A and 3B are a more detailed block diagram of an apparatus for determining which items in a transaction are associated with which individuals from a group of individuals, in accordance with embodiments of the present invention;

FIG. 4 is a flow diagram of a method for determining which items in a transaction are associated with which individuals from a group of individuals in accordance with embodiments of the present invention; and

FIG. 5 is a schematic diagram of an operating environment for determining which items in a transaction are associated with which individuals from a group of individuals, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and high-definition DVD disc where disks usually reproduce data magnetically, while discs usually reproduce data optically with lasers. Combinations of the above should also be included within the scope of computer-readable media.

Thus, embodiments of the present invention provide, within a personal finance management application (e.g., online banking, mobile banking or the like), customer-based transaction filtering for shared financial accounts (i.e., joint account or accounts otherwise held by more than one individual/customer). The filtering is configured to present holders of the shared accounts views (e.g., windows, sortable lists or the like) of which transactions, and in some embodiments which items in those transactions, were conducted by which holders of the account.

The present invention relies on receipt of transaction item-identifying data, such as e-receipt data or the like to determine that a transaction is associated with a shared account and identify which holder of the shared account conducted the transaction based on information if the transaction item-identifying data, such as an addressee of the e-receipt or the like. Once the transactor (i.e., individual or entity that conducted the transaction) has been identified, the customer-based transaction filtering function within the personal finance management application allows holders of the account to have access to a breakdown of which transactions were conducted by which holders of the account.

In the past few years, there has been an increase in the amount of electronic information provided by merchants to customers regarding purchase of products and services. In the online purchase context, various electronic communications may be provided to the customer from the merchant relative to a purchase. For example, following an online purchase, the merchant may provide the customer an electronic order confirmation communication. The order confirmation may be sent to the customer's computer and displayed in a web browser application. The web browser application typically allows the customer to print a hard copy of the order confirmation and to save the confirmation electronically. The merchant will also typically send an email containing the order confirmation to the customer's designated email account. The order confirmation is otherwise referred to as an electronic receipt, commonly referred to as an e-receipt, for the online purchase. The order confirmation includes detailed information regarding the products or services purchased. For example, in the case of a product, the order confirmation may include stock keeping unit “SKU” code level data, as well as other parameters, such as an order number, an order date, a product description, a product name, a product quantity, a product price, a product image, a product image or a hyperlink to the product image on a merchant website, the sales tax incurred, the shipping cost incurred, an order total, a billing address, a third party shipping company, a shipping address, an estimated shipping date, an estimated delivery date, a shipment tracking number, and the like. The order confirmation also includes information about the merchant, such as the name of the merchant, the address of the merchant, a telephone number of the merchant, a web address, and the like. For most online transactions, the merchant will send at least one second communication confirming shipment of the order. The order shipment confirmation is typically also sent via email to the customer and typically includes the same information as the order confirmation, and in addition, a shipping date, a shipment tracking number, and other relevant information regarding the order and shipment parameters.

Many merchants now also provide the option for customers to receive e-receipts when shopping at “brick and mortar” locations (i.e., physical locations). In general, at the point of sale, the customer may have previously configured or may be asked at the time of sale as to whether he or she wishes to receive an e-receipt. By selecting this option, the merchant will send an electronic communication in the form of an e-receipt to the customer's designated email address. Here again, the e-receipt will typically include a list of services and/or products purchased with SKU level data, and other parameters, as well as information about the merchant, such as name, address, phone number, store number, web address, and the like.

Various merchants now also provide online customer accounts for repeat customers. These online customer accounts may include purchase history information associated with the customer, which are accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at “brick and mortar” locations and then store these transactions in the customer's online account.

For the most part, order confirmations, shipping confirmations, e-receipts, and other electronic communications between merchants and customers are used only by the customer as proof-of-purchase and for monitoring receipt of purchased items (i.e., for archival purposes). However, there is significant data that can be gleaned from this electronic information for the benefit of the customer, so that the customer may have detailed information regarding purchase history, spending, and the like.

Another development in the past few years has been the growth of online banking, mobile banking and the like, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction date, but also to manage finances. A current drawback with online banking is that transactional level detail for a given purchase by the customer is limited. Despite the large amount of information sent by merchants to customers regarding purchases, merchants currently do not provide purchase details to financial institutions. The only information provided by the merchant to the financial institution is information about the merchant and an overall transaction amount. For example, if a financial institution customer purchases several clothing items from a merchant and uses a financial institution debit card, credit card or a check, all that is provided to the financial institution is the merchant information and overall purchase amount. Product level detail that is present on the receipt provided to the customer by the merchant is not provided to the financial institution.

The lack of detailed information regarding a given transaction in the online banking environment limits a customer's ability to ascertain a larger picture of purchase history and financial transaction information. As a first example, if a customer makes several purchases within a short time period with a particular merchant, all that the customer will see in online banking for each purchase is an overall dollar amount, the merchant name, and date of the purchase transaction. If the customer cannot recall, what a particular purchase was for or whether it was a legitimate transaction, the customer cannot view details regarding the purchase via online banking to aid in the inquiry. Instead, the customer must locate and review receipts from the purchases and match them by date and/or total purchase amount to online banking data to perform such analysis.

Lack of detailed purchase information also hinders use of other financial tools available to the customer in online banking, such as budgetary tools. In general, budgetary tools divide expenses into various categories, such as food, clothing, housing, transportation, and the like. It is typically advantageous to provide such budget tools with online banking information to populate these various categories with spend information. However, this is difficult where specifics regarding a purchase made by the merchant (such as SKU level data) are not provided by the merchant to the financial institution for a given financial transaction. As many stores provide a wide variety of services and products, such as in the case of a “big box” store that provides groceries, clothing, house hold goods, automotive products, and even fuel, it is not possible to dissect a particular purchase transaction by a customer at the merchant for budget category purposes. For this reason, many current online budgeting tools may categorize purchases for budgeting by merchant type, such as gas station purchases are categorized under transportation and grocery store purchases are categorized under food, despite that in reality, the purchase at the gas station may have been for food or the purchase at the grocery store could have been for fuel. Alternatively, some budget tools may allow a customer to parse the total amount of a purchase transaction between budget categories by manually allocating amounts from the purchase transaction between each budget category. This requires added work by the customer and may be inaccurate, if the customer is not using the receipt in making such allocations or the customer fails to recall exactly what items were purchased in previous transactions.

Traditional cash purchases are also problematic for integration of customer purchase transactions into online banking. In a cash transaction, the customer may initially withdraw cash from a financial account and then use the money for a purchase. In this instance, the customer's online banking will have no information whatsoever regarding the purchase transaction with a merchant, as there is no communication regarding the purchase transaction between the financial institution and the merchant. For example, if the customer uses cash to purchase fuel at a gas station, the financial institution has no way of determining that the purchase transaction occurred and cannot use such information for notifying the customer of spending or budgeting regarding the fuel purchase.

As described above, currently financial institutions are not provided with detailed transaction level information regarding a purchase transaction by a customer from a merchant beyond merchant information and overall transaction price for inclusion in online banking. While detailed data (such as SKU level data) is provided to the customer via receipts, such information is not provided by the merchant to the financial institution. The information is available to the customer but not integratable into a customer's online banking for efficient and increased beneficial use of the information. Currently, a customer must retain her receipts and manually compare such receipts with online purchase transaction data and manually input related data into online banking to obtain an understanding of the details of a given purchase transaction.

In light of the above, the current invention contemplates use of purchase confirmation or e-receipt data and other electronic communication data between a merchant and customer regarding a transaction (referred to herein as transaction item-identifying data) in order to augment purchase transaction data in online banking, mobile banking and the like. The general concept is to retrieve such electronic communications from the customer, parse the data in these electronic communications, and associate the data from the electronic communications with the corresponding online purchase transaction data.

An initial barrier to integration of electronic communication data received by a customer from a merchant regarding a purchase transaction for inclusion into online banking is data format. Online banking data is in a structured form. Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply to a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form.

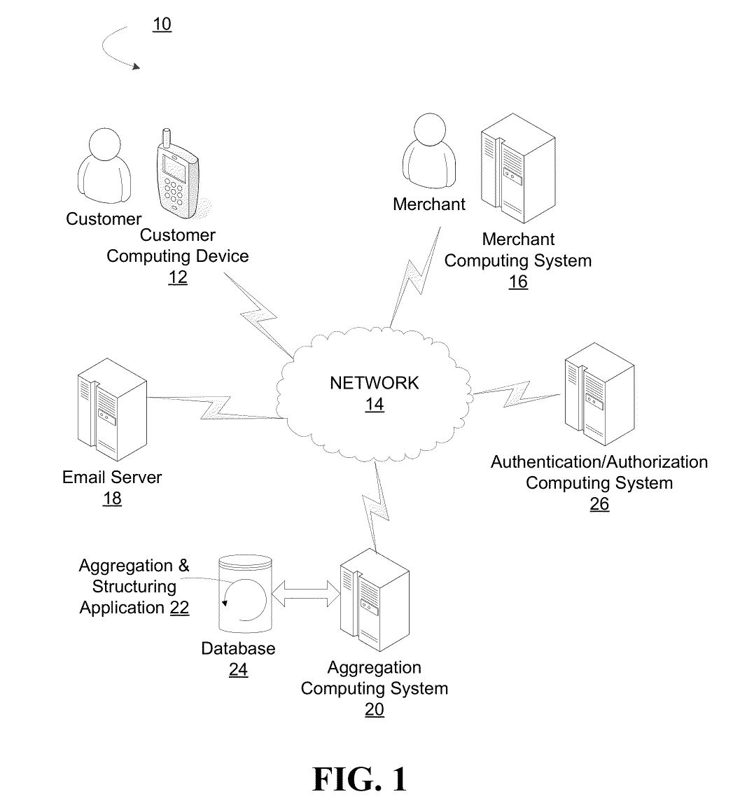

FIG. 1 is a diagram of an operating environment 10 according to one embodiment of the present invention for retrieval of electronic communications relating to customer purchase transactions, parsing of data within such electronic communications into structured data, formatting the data for financial institution accessibility and inclusion of such data into a network-accessible banking application, such as online or mobile banking. As illustrated a consumer maintains one or more computing devices 12, such as a PC, laptop, mobile phone, tablet, television, or the like that is network accessible for communicating across a network 14, such as the Internet, wide area network, local area network, short range/near field network, or any other form of contact or contactless network. Also, in the operating environment, are one or more merchant computing systems 16 that is network accessible. In the context of an online shopping experience, the merchant computing system 16 may be one or more financial transaction servers that, either individually or working in concert, are capable of providing web pages to a customer via the network 14, receiving purchase orders for items selected by the customer, communicating with the customer and third party financial institutions to secure payment for the order, and transmitting order confirmation, and possibly shipping confirmation information, to the customer via the network 14 regarding the purchase transaction. In the context of an in-store purchase, the merchant computing system 16 may include a point of sale terminal for scanning or receiving information about products or services being purchased by the customer and communicating with the customer and third party financial institutions to secure payment for the order. Either the point of sale device or a connected merchant server may be used to communicate order confirmation or purchase confirmation information (e.g., e-receipt) to the customer related to the purchase transaction. If the customer has an online account with the merchant, the merchant computing system may also log the transaction information into the customer's online account.

In general, the merchant computing system will provide the customer with information relating to the purchase transaction. In the context of an online purchase, the communications may take the form of purchase order confirmations provided as a web page or as an email or as both. In some, embodiments, the merchant computing system may provide a web page purchase order confirmation, and advise the customer to either print, electronically save, or book mark the confirmation web page. The purchase order confirmation is essentially an e-receipt for the online purchase transaction. The order confirmation includes detailed information regarding the products or services purchased, such as for example, in the case of a product, SKU code level data, as well as other parameters associated with the product, such as type/category, size, color, and the like, as well purchase price information, information associated with the merchant, and the like. The merchant computing system may also send other subsequent communications, such as communications confirming shipment of the order, which typically includes the same information as the purchase order confirmation, and in addition, shipping date, tracking number, and other relevant information regarding the order. In the context of an in-store purchase, the merchant computing system may send an e-receipt comprising information similar to that of the purchase order confirmation. In some instances, the customer may actually receive a paper receipt, which the customer may choose to scan into an electronic form and save in a storage device associated with the customer computing device 12. In the description herein, the term e-receipt may be used generically to refer to any communication or document provided by a merchant to a customer relating to a purchase transaction.

For a plurality of different purchase transactions, a customer may include purchase transaction item-identifying data (e.g., order confirmations, shipping confirmations, e-receipts, scanned receipts, typed or handwritten notes, invoices, bills of sale, and the like) in various locations and in various forms. The transaction item-identifying data could be stored in a storage device associated with the customer computing device 12, or in an email server 18, or in a customer's account at the merchant's computing system 16. Furthermore, as mentioned, the transaction item-identifying data is in an unstructured format. Each merchant may use a customized reporting format for the communications, whereby various data relating to the purchase transaction may be placed in different sequences, different locations, different formats, etc. for a given merchant. Indeed, a given merchant may even use different data formatting and structuring for different communications with the customer (e.g., order confirmation, shipping, confirmation, e-receipt, online customer account information, and the like).

To aggregate and structure data related to purchase transactions, the operating environment further comprises an aggregation computing system 20 including aggregation and structuring application 22 stored in database 24. The aggregation computing system 20 is operatively connected to at least one of the customer computing device 12, the merchant computing system 16, and the email server 18 via the network 14. The aggregation and structuring application 22 is configured to initially crawl (i.e., search and locate) electronic communications associated with purchase transactions made by the customer, in for example, the customer's email, computer storage device, online accounts, and the like. For this purpose, the system may optionally include an authentication/authorization computing system 26 that comprises security IDs and passwords and other security information associated with the customer for accessing customer's email, storage devices, and customer online accounts.

Regarding email extraction, aggregation and structuring application 22 initially gains access to the customer's email accounts and retrieves email message headers comprising data fields relative to the email message, such as sender, subject, date/time sent, recipient, and the like. In some embodiments, the aggregation computing system accesses the emails directly. In other embodiments, the aggregation computing system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “return,” “pre-order,” “pre-ordered,” “tracking,” “on its way,” “received,” “fulfilled,” “package,” and the like.

Based on the email header analysis, the message bodies for emails of interest may then be accessed. The retrieved email message bodies for the identified email messages of interest are parsed to extract the purchase transaction information and/or shipping information contained therein. Such parsing operation can occur in a variety of known ways. However, because the text included in email message bodies is unstructured (as opposed to the structured tagged elements in a hypertext markup language (HTML) web page, which delineate and make recognizable the various fields or elements of the web page), in one embodiment predefined templates are used that have been specifically created to identify the various individual elements or entities of interest in a given email from an online merchant. Use of these predefined templates to parse a retrieved email message body occurs within aggregation and structuring application 22. Because it is known from header information which merchant sent the email message of interest and whether the email message is a purchase order confirmation or a shipping confirmation from either the header or the message body information, a template specific to the merchant and type of confirmation may be used. Still further, because email message bodies can, as is known in the art, be in either a text or HTML format, a template specific to the type of email message body format may be used in some embodiments.

As an example, for each merchant there are typically four different parsing templates which can be used for electronic communications relating to purchase transactions: i) a text order confirmation template; ii) an HTML order confirmation template; iii) a text shipping confirmation template; and iv) an HTML shipping confirmation template. In instances in which the email is an e-receipt from a “brick and mortar” purchase, another template may be used that is specific to the merchant. For some online merchants there are greater or fewer templates depending upon what are the various forms of email messages a given online merchant typically sends. Regardless of the number of templates for a given merchant, each template is specific as to the known particular entities typically included and the order they typically occur within each type of email confirmation message sent by that merchant.

The above describes parsing of email purchase order confirmation, shipping confirmation, or e-receipt data. As mentioned, a customer may scan and save paper receipts, typed or printed notes, invoices, bills of sale, and the like in a storage device or print and save purchase order and shipping confirmation communications sent to the customer by the merchant via a web page. In this instance, the aggregation and structuring application 22 may first perform optical character recognition “OCR” on the scanned or printed receipts prior to perform the processing performed above. Further, a customer may maintain an online account with a merchant containing purchase data information. In this instance, the aggregation computing system 20 will access the data online via communication with merchant computing system to retrieve this data. The aggregation computing system 20 may use column and/or row headers associated with the online data to parse the data, or it may use procedures similar to the above and discussed below to parse the data into appropriate fields.

Returning to data processing procedures, in some embodiments, context-free grammars “CFGs” are used to parse fields from purchase transaction data. In some embodiments, instead of using grammars for parsing natural language (e.g., English) structures, the system may use defined smaller grammars describing a particular message format, for example: “(Greetings from merchant)(Details about order)(Details about item 1) (Details about item 2) . . . (Details about item N)(Tax and totals calculation),” and the like. Further, the CFGs may be individually defined, such as in a Backus-Naur Form (BNF) format, or templates may be used for data extraction. In instances, where templates are used, these created templates are grammar and can be converted by known tools, such as Another Tool for Language Recognition “ANTLR”, into mail-specific grammars or e-receipt-specific grammars or online customer account information-specific grammars. ANTLR is then used again to convert these grammars into extraction parsers, which can be used by the aggregation computing system 20 to parse the email message bodies, e-receipt bodies, online data, etc. to extract the entities of interest from them. Examples of such extracted entities include merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

Once the data has been properly parsed, the data may be required to be formatted to conform to financial institution specifications. For example, as previously noted, the data may be formatted to conform to Open Financial Exchange “OFX” specifications for the electronic exchange of financial data between financial institutions, businesses and customers via the Internet.

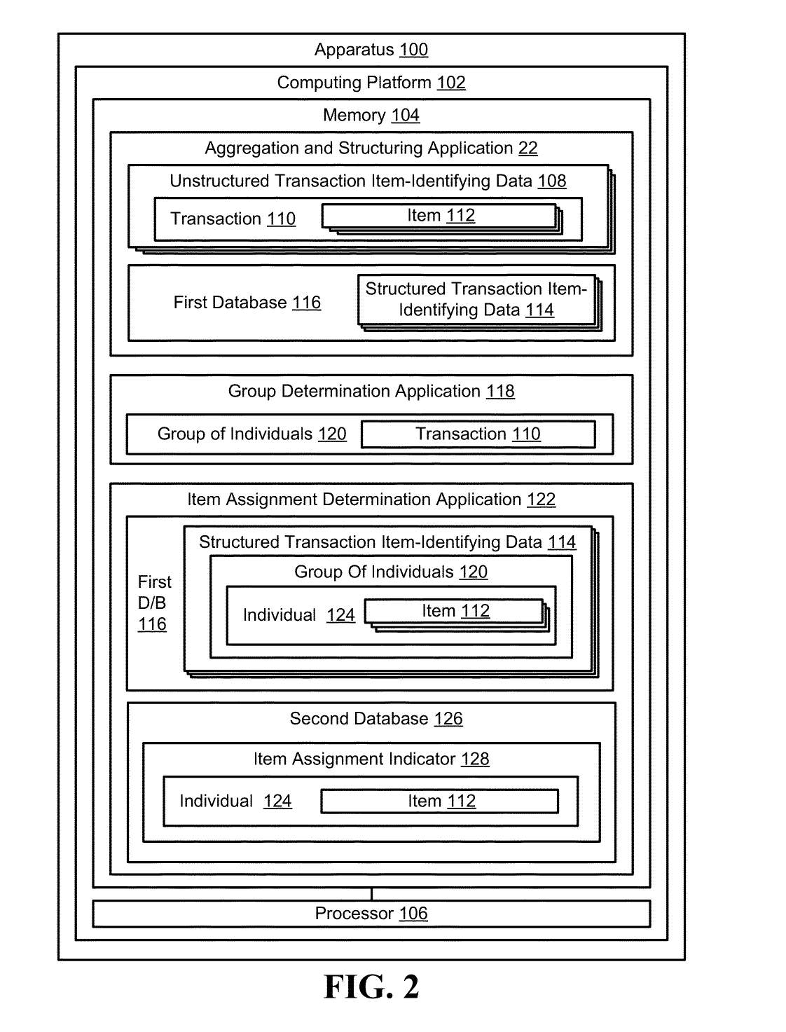

FIG. 2 provides a block diagram of an apparatus 100 configured for identifying which items in a transaction are associated with which individuals from a group of individuals, in accordance with embodiments of the present invention. The apparatus 100 includes a computing platform 102 having a memory 104 and at least one processor 106 that is communication with the memory 104. The memory 104 of apparatus 100 stores aggregation and structuring application 22 that is executable by processor 106 and configured to receive unstructured transaction identifying-data 108, such as an e-receipt, including a purchase confirmation, a shipping confirmation; a scanned receipt and the like, associated with a transaction 110 that includes one or more items 112, process the data to result in structured transaction item-identifying data 114 and store the structured transaction item-identifying data 114 in an associated database (first database) 116. The processing of such data is described in detail in relation to FIG. 1 and may include crawling email accounts to collect e-receipts and other transaction item-identifying data from a customer's email account, parsing the transaction item-identifying data using predetermined templates to render structured item-identifying data and other relevant data from the e-receipts and the like, and formatting the data in a format accessible to financial institution systems, such as personal finance management systems (e.g., online banking, mobile banking and the like).

Memory 104 of apparatus 100 additionally includes group determination application 118 that executable by processor 106 and is configured to determine that the transaction 110 is associated with a group of individuals 120, such as a household (i.e., more than one individual that shares a dwelling), a small business or the like. In specific embodiments, the group determination application 118 may further be configured to determine that the group of individuals 120 has requested assignment of items in the transaction to individuals in the group, while in other embodiments of the invention the mere fact that a group of individuals has been determined indicates that assignment of items in the transaction has been requested by the group.

Additionally, memory 104 of apparatus 100 includes item assignment determination application 122 that is executable by processor 106 and configured to access the structured item-identifying data 114 in the first database 116 to determine which individual 124 from the group of individuals 120 to assign to one or more items 112 in the transaction 110. Further, in response to determination of which individual 124 to assign to an item 112, the item assignment determination application 122 is further configured to generate and store in a second database 126 an item assignment indicator 128 that indicates that the individual 124 is assigned to the item 112. The second database 126 may be associated with a personal finance management application, such as an online banking application, a mobile banking application or the like.

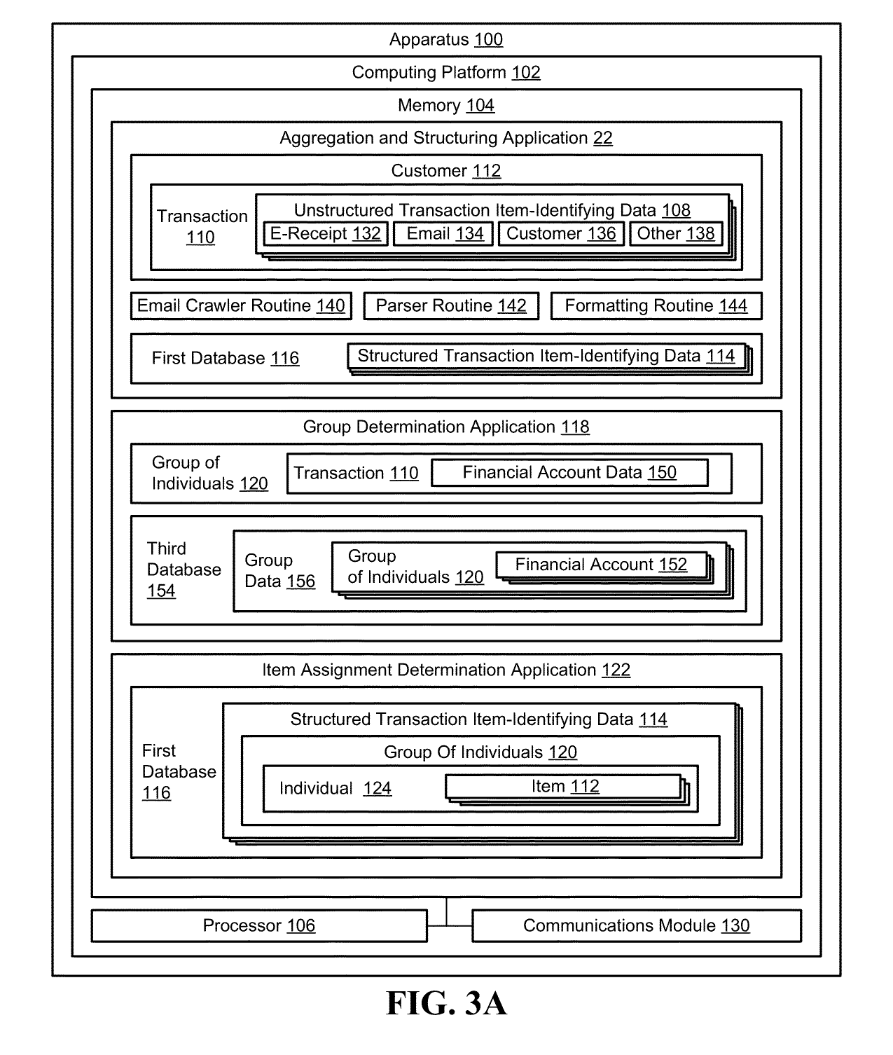

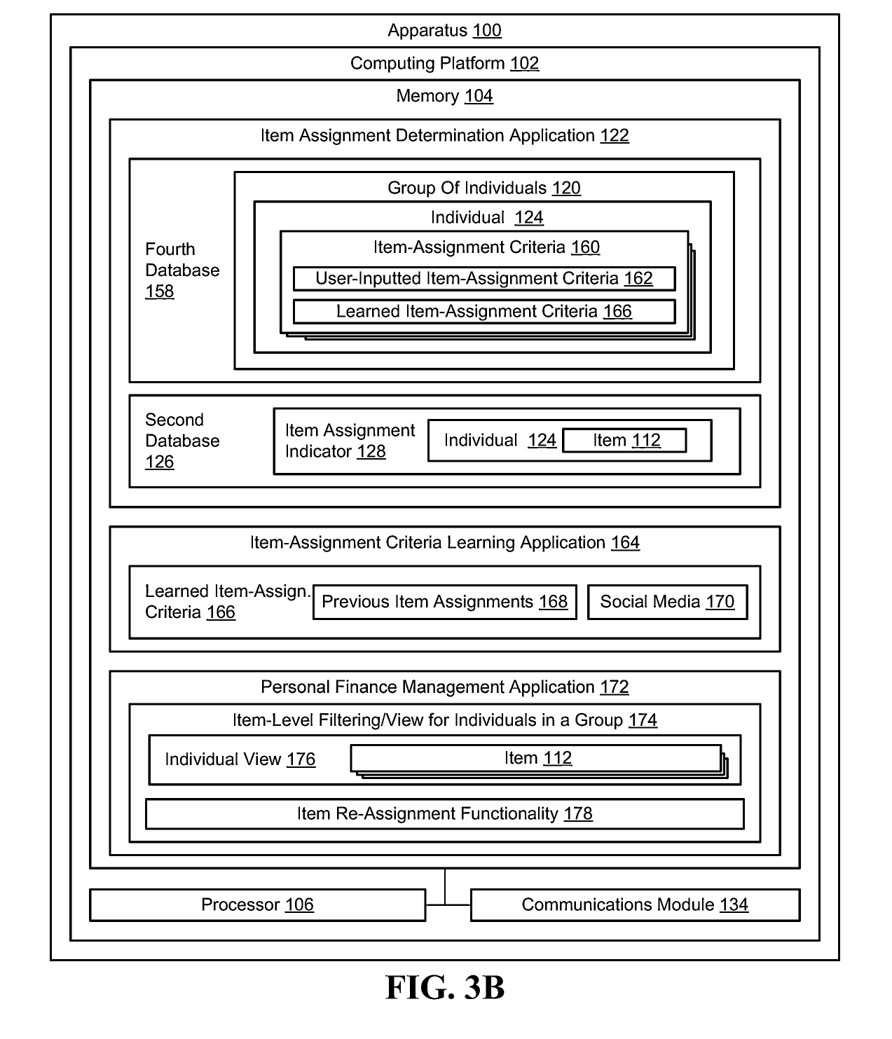

Referring to FIGS. 3A and 3B, shown is a more detailed block diagram of apparatus 100, according to embodiments of the present invention. As previously described, the apparatus 100 is configured to identify which items in a transaction are associated with which individuals from a group of individuals. In addition to providing greater detail, FIGS. 3A and 3B highlight various alternate embodiments of the invention. The apparatus 100 may include one or more of any type of computerized device. The present apparatus and methods can accordingly be performed on any form or combination of computing devices, including servers, personal computing devices, laptop/portable computing devices, mobile computing devices or the like.

The apparatus 100 includes computing platform 102 that can receive and execute routines and applications. Computing platform 102 includes memory 104, which may comprise volatile and non-volatile memory, such as read-only and/or random-access memory (RAM and ROM), EPROM, EEPROM, flash cards, or any memory common to computer platforms. Further, memory 104 may include one or more flash memory cells, or may be any secondary or tertiary storage device, such as magnetic media, optical media, tape, or soft or hard disk.

Further, computing platform 102 also includes processor 106, which may be an application-specific integrated circuit (“ASIC”), or other chipset, processor, logic circuit, or other data processing device. Processor 106 or other processor such as ASIC may execute an application programming interface (“API”) (not shown in FIGS. 3A and 3B) that interfaces with any resident programs, such as aggregation and structuring application 22, group determination application 118, item assignment determination application 122, item-assignment criteria learning application 164 and personal finance management application 172 or the like stored in the memory 104 of the apparatus 100.

Processor 106 may include various processing subsystems (not shown in FIGS. 3A and 3B) embodied in hardware, firmware, software, and combinations thereof, that enable the functionality of apparatus 100 and the operability of the apparatus on a network. For example, processing subsystems allow for initiating and maintaining communications and exchanging data with other networked devices. For the disclosed aspects, processing subsystems of processor 106 may include any subsystem used in conjunction with aggregation and structuring application 22, group determination application 118, item assignment determination application 122, item-assignment criteria learning application 164 and personal finance management application 172 or subcomponents or sub-modules thereof.

Computer platform 102 additionally includes communications module 130 embodied in hardware, firmware, software, and combinations thereof, that enables communications among the various components of the apparatus 100, as well as between the other devices in the transaction system, the aggregation and structuring system and/or the financial institution system. Thus, communication module 130 may include the requisite hardware, firmware, software and/or combinations thereof for establishing a network communication connection and initiating communication amongst networked devices.

As previously noted and shown in FIG. 3A, the memory 104 of computing platform 102 stores aggregation and structuring application 22 that is executable by processor 106 and configured to receive unstructured transaction identifying-data 108, such as e-receipts 132, (e.g., purchase confirmations, shipping confirmations), other relevant emails 134, customer inputted data 136 (e.g., scanned hard-copy receipts or manually inputted hard copy receipt data) and any other data 138 indicating a transaction conducted by the customer and the items included in the transaction, and process the data to result in structured transaction item-identifying data 114. In specific embodiments of the invention, the aggregation and structuring application 22 includes email crawler routine 144 that is configured to crawl email accounts(s) of the customer to identify and collect emails containing transaction data. Details of the email crawler routine 144 are discussed in relation to FIG. 1. The emails may include e-receipts, which collectively include, purchase confirmations, shipping confirmations, and any other emails indicating a transaction and the items included in the transaction.

The aggregation and structuring application 22 may additionally include parser routine 146 that is configured to implement predetermined templates to parse relevant data from the unstructured transaction item-identifying data 108. As discussed in detail in relation to FIG. 1, the predetermined templates may be configured to parse data such as, but not limited to, merchant name, merchant contact information, transaction location (i.e., physical location or online), item identifiers, such as SKUs, UPCs or the like, item names, item amount, total purchase amount, tax amount, data and time or transaction, shipping information and the like.

The aggregation and structuring application 22 may additionally include formatting routine 148 that is configured to format the parsed data into a format that is compatible and/or accessible to financial institutions. For example, in specific embodiments, the parsed data may be formatted to conform to Open Financial Exchange “OFX” specifications for the electronic exchange of financial data between financial institutions, businesses and customers via the Internet. Once parsed and formatted, the structured transaction item-identifying data 114 may be stored in a requisite first database 116 for subsequent access by the financial institution or other entities authorized by the customer to have access to such transaction item-identifying data 114.

As previously discussed in relation to FIG. 2, the memory 104 of apparatus 100 additionally includes group determination application 118 that executable by processor 106 and is configured to determine that the transaction 110 is associated with a group of individuals 120, (e.g., a household, a small business, a social network of individuals or the like). In specific embodiments of the apparatus, the group determination application 118 is configured to match financial account data 150, such as account number or the like, associated with the transaction 110 to group data 156 stored in a third database 154 that associates financial accounts 152 with groups of individuals 120.

As discussed in relation to FIG. 2, memory 104 of apparatus 100 includes item assignment determination application 122 that is executable by processor 106 and configured to access the structured item-identifying data 114 in the first database 116 to determine the individual 124 from the group of individuals 120 to assign to one or more items 112 in the transaction 110. Thus it should be noted that in certain instances not all of the items in a transaction may be assignable to individuals in a group. For example, if the transaction includes generic household items, such as laundry detergent, paper products or the like, these items are not assigned to an individual in the group. In specific embodiments of the invention the item assignment determination application 122 is configured to determine the individual 120 to assign to an item 112 by accessing a fourth database 158 (shown in FIG. 3B) that stores item-assignment criteria 160 for each individual 124 in the group of individuals 120.

In specific embodiments of the invention the fourth database 158 stores individual profiles of each individual 124 in the group of individuals 120. The individual profiles include data related to the individual that assists in determining what items should be assigned to the individual. For example, the individual profiles may include clothes/shoe sizes, hobbies, interests, food items, favorite recording artists and the like. In specific embodiments, the individual profiles include user-inputted item-assignment criteria 162, such that individuals in the group may input their own item-assignment criteria 160. In such embodiments, the user may be presented with a questionnaire or the like that asks the individual questions relevant to determining what items should be assigned to the individual.

In other embodiments of the invention the memory 104 of apparatus 100 stored item-assignment criteria learning application 164 that is executable by processor 106 and configured to learn, over time, learned item-assignment criteria 1166 based on previous item assignments 168 or monitoring social media 170 entries made by the individual that indicate the individuals interests and the like or online merchant wish lists. In such embodiments of the invention, the fourth database 116 stores the learned item-assignment criteria 166.

In specific embodiments of the invention the item-assignment criteria 112 that is relied to determine item assignment is a combination of user-inputted item-assignment criteria 162 and learned item-assignment criteria 166. The learning nature of such embodiments of the invention means that the item-assignment process will be more accurate over time as item-assignment criteria 112 becomes more robust (i.e., knows more about each individual in the group). In addition, the learning nature of such embodiments takes into account that fact that items assignable to individuals may change over time due to individuals interests changing and/or physical growth (e.g., children changing clothes/shoe sizes).

As discussed in relation to FIG. 2, the item assignment determination application 122 is further configured to, in response to determining an individual 124 to assign to item 112, generate and store an item assignment indicator 128 in a second database 126, such as a database associated with personal finance management application 172, such as online or mobile banking.

In specific embodiments of the invention, the memory 104 of apparatus 100 further stores personal finance management application 172, which may be an online or mobile banking application or the like. The personal finance management application 128 is configured to provide item-level filtering/view 174 for individuals in the group. The item-level filtering 174 results an individual view 176 that displays the items 112 in the transactions 110 that have been automatically assigned to the corresponding individual 124. In addition to displaying the items 112 the individual view 176 may include other information about the items such as date of purchase, merchant, purchase amount of the item, total amount for the individual and the like. Further filtering within the individual view 176 may provide for displaying only those items over a designated period of time, e.g., current calendar month, previous twelve months/year, year-to-date or the like. In specific embodiments the personal finance management application is configured to allow an individual in the group access to all individual views of individuals in the group, while in other embodiments the application may be configured by the user to only allow for the individual to view their individual view 176 or individual views 176 designated as being viewable by the individual (e.g., parents may be configured to view children's individual views while children may be configured to only view their own individual view).

In specific embodiments of the invention, the application 173 is further configured to provide for item re-assignment functionality 178 that allows individuals viewing item assignments to re-assign an item that has been automatically assigned to an incorrect individual. Such re-assignment functionality 178 is configured to designate an item as generic (i.e., not to be assigned to a specific individual in the group) or re-assign an item to another individual in the group.

In addition, the personal finance management application 128 may be configured to provide peer comparison views (not shown in FIGS. 3A and 3B) for like individuals (e.g., same age, similar demographics, similar health profiles) or like groups of individuals (e.g., similar households, similar small businesses). The peer comparison views may provide for peer comparison of a single unidentified individual or group of individuals or the peer comparison view may provide for an averaging of a plurality of like individuals or a plurality of like groups of individuals. In this regard, an individual can compare their budget expenditures to similarly situated individuals and gleam from the comparison whether expenditures can be improved upon, curtailed or the like.

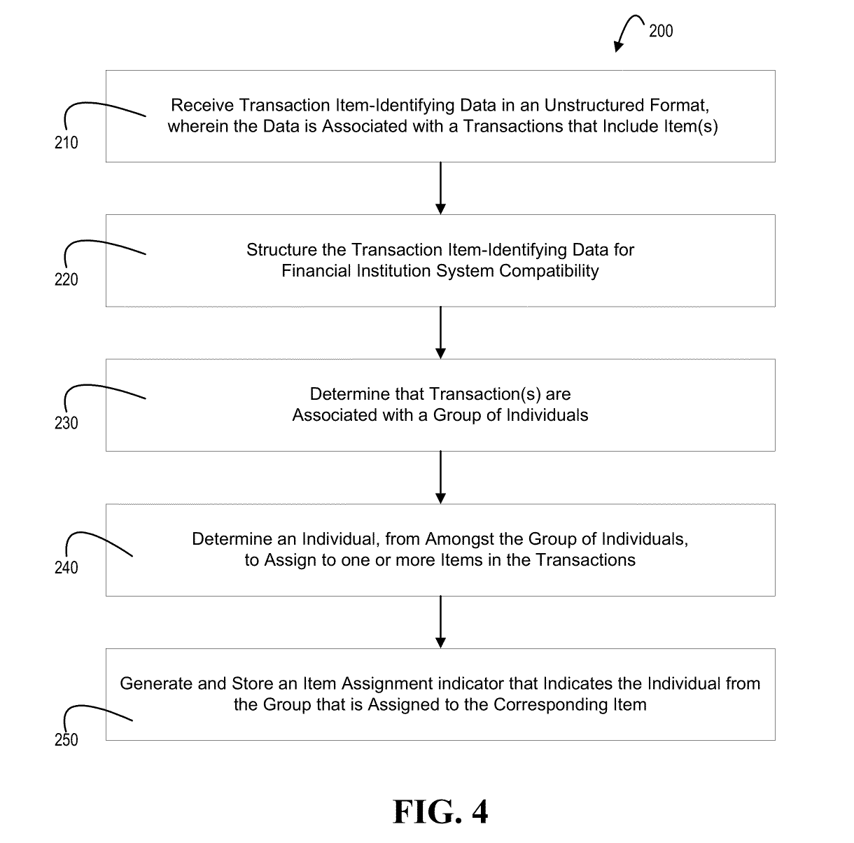

Referring to FIG. 4, a flow diagram of a method 200 for identifying which items in a transaction are associated with which individuals from a group of individuals, in accordance with embodiments of the present invention. At Event 210, transaction item-identifying data is received in an unstructured format. The transaction item-identifying data is associated with a transaction conducted by the customer and may include e-receipts (e.g., purchase confirmation emails, shipping confirmation emails or the like), data from receipts scanned by the customer/user or manually inputted by the user/customer or data otherwise received or harvested form a merchant or customer. In specific embodiments of the invention, the transaction item-identifying data is received by crawling one or more email accounts associated with the customer to identify emails received that include the transaction item-identifying data (i.e., purchase confirmation emails, shipping confirmation emails or the like).

At Event 220, the unstructured transaction item-identifying data is structured for financial institution system capability. Structuring of the data may include applying a predetermined template to the data to parse or otherwise identify data that has been identified as relevant. The template(s) that is/are chosen to be applied to the data may be based on the form of the transaction item-identifying data, i.e., certain templates may apply to e-receipts, other templates may apply to customer inputted or scanned data. In addition to parsing data from the unstructured transaction item-identifying data, structuring the data may include reformatting the data to a format compatible with financial institution processing. For example, in specific embodiments, the data may be reformatted to conform to Open Financial Exchange “OFX” specifications for the electronic exchange of financial data between financial institutions, businesses and customers via the Internet. Once parsed and reformatted the structured data may be stored in associated database.

At Event 230, a transaction is determined to be associated with a group of individuals. Such determination will provide indication that items in the transaction should be assigned to individuals in the group. In specific embodiments a transaction is determined to be associated with a group by matching a financial account identifier associated with the transaction (i.e., credit/debit account number) with group identifying data that associates financial accounts with groups. The group identifying data may be stored at or by a financial institution and the account to group associations may be made at the bequest of the group and/or financial institution.

At Event 240, individuals, from amongst the group of individuals, are determined to be assigned to one or more of the items in the transaction. In specific embodiments of the method, the determination of which individuals should be assigned to which items is conducted by matching the structured item-identifying data to item-assignment criteria associated with each of the individuals in the group. The item-assignment criteria may be user/individual-inputted item-assignment criteria, such as individual profile that includes individual attributes associated with items (e.g., clothes/shoe sizes, hobbies, interests and the like). In additional embodiments the item-assignment criteria may be learned, over time based on previous/historical item assignments and/or monitoring the individual's entries to social media. In specific embodiments the item-assignment criteria may be a combination of both user/individual-inputted item-assignment criteria and learned item-assignment criteria.

At Event 250, an item assignment indicator is generated and stored in a database, such as a database associated with a personal finance management application, such as online or mobile banking or the like. The item assignment indicator provides indication that an item in the transaction has been assigned to a specified individual in the group. In specific embodiments of the method such an item assignment indicator is relied upon to provide item-level filtering/views for the individuals within the group within the personal finance management application. In further embodiments of the method, the item-level filtering/views provide for individuals to re-assign items to other individuals, or designate an item as group generic, if an item has been incorrectly assigned by the automated process herein disclosed.

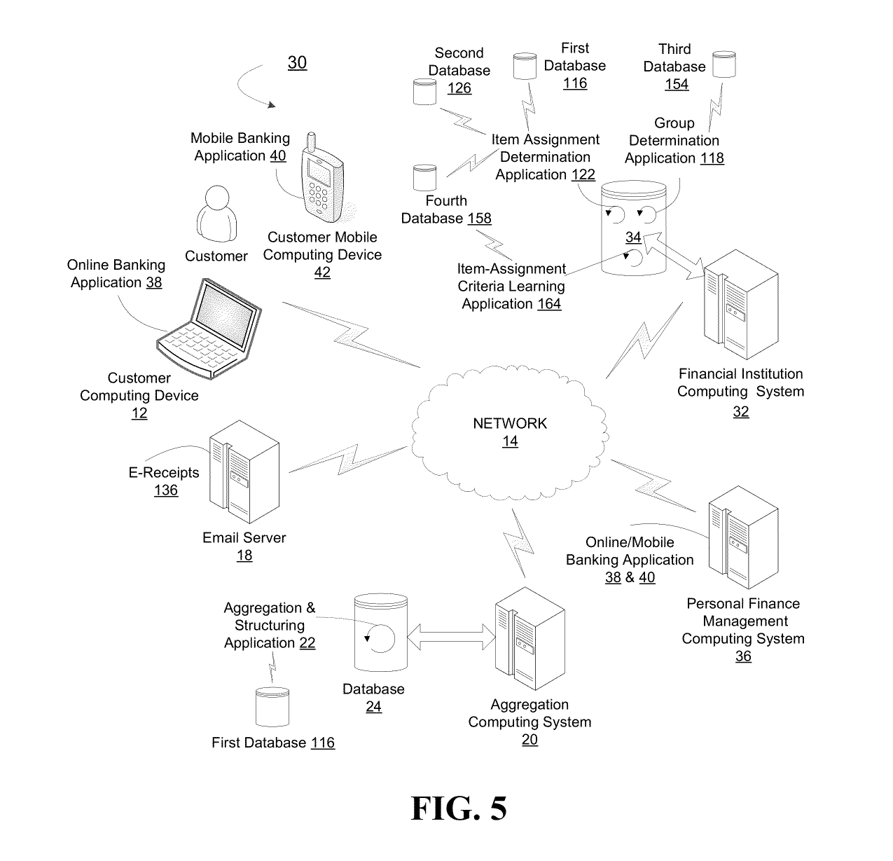

Referring to FIG. 5 a schematic diagram 30 is provided of a computing network environment for implementing embodiments of the present invention. The network 14 which serves as the communication hub may comprise any combination of one or more of the Internet, a wide area network, a local area network, a short range/near field network or any other form of contact or contactless network. The aggregation computing system 20 receives transaction item-identifying data in an unstructured format. The transaction item-identifying data is associated with a transaction that includes one or more items. In specific embodiments, the transaction item-identifying data are emails, such as e-receipts 136 obtained from crawling email accounts stored on email server 18. The aggregation computing system includes database 24 which stores aggregation and structuring application 22, which is configured to structure the unstructured transaction item-identifying data for financial institution compatibility. Structuring of the data may include parsing the unstructured data using predetermined templates and/or formatting the data to a format compatible with financial institution standards for communication and presentation. Once the data has been properly structured the data may be stored in first database 116.

Financial institution computing system 32 is in communication with database 34 and stores group determination application 118 that is configured to determine that the transaction is associated with a group of individuals. In specific embodiments such a determination is made by accessing third database 154 that stores group data that associates financial accounts to groups of individuals and comparing the group data to a financial account identifier, such as credit/debit account number or the like, associated with the transaction. The database 34 also includes item assignment determination application 122 that is configured to determine an individual from amongst the group of individuals to assign to item(s) in the transaction. Such a determination is made by accessing the structured item-identifying data in the first database 116 and, in specific embodiments, comparing the item-identifying data to item-assignment criteria stored in the fourth database 158. In further specific embodiments the database 34 also stores item-assignment criteria learning application 162 is configured to learn the item-assignment criteria based on previous/historical item assignments and/or social media entries by the individuals. The learned item-assignment criteria is stored in fourth database 158 and accessed by the item assignment determination application 122 when determining item assignments for items in transaction.

The environment 30 also includes personal finance management computing system 36 which may include a portion or all of financial institution computing system 32 or may be a separate entity of the financial institution or of a third party is configured to execute personal finance management applications, such as online banking application 38 or mobile banking application 40. The personal finance management application is configured to provide item-level filtering for individuals in groups of individuals. The filtering is configured to present the individuals in the group, via customer computing device 12, which accesses online banking application 38 and customer mobile computing device 42, which accesses mobile banking application 40, with views of which items are assigned to which individuals in the group for budgetary purposes or the like.

Thus, the present invention as described in detail above, provides for automatically determining which individual, from amongst a group of individuals, for example, a household, should be assigned which items in a transaction for the purpose of assessing budget for the group on a per-individual level. Transaction item-identifying data, such as an e-receipt is analyzed to identify items in a transaction, the transaction is determined to be associated an account that is tied to a group of individuals and the items in the transaction are determined to belong to or otherwise, for budgetary purposes, assignable to an individual belonging to the group.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention. While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for identifying which items in a transaction are associated with which individuals from a group, the apparatus comprising:
a computing platform having a memory and at least one processor in communication with the memory device;
an aggregation and structuring application stored in the memory, executable by the processor and configured to receive transaction item-identifying data in an unstructured format, wherein the transaction item-identifying data is associated with transactions including one or items, structure the transaction item-identifying data for financial institution compatibility and store the structured data in a first database;
a group determination application stored in the memory, executable by the processor and configured to determine that one or more of the transactions are associated with a group of individuals;
an item assignment determination application stored in the memory, executable by the processor and configured to (1) access the item-identifying data in the first database to determine an individual from the group of individuals to assign to one or more of the items in the transactions and (2) generate and store an item assignment indicator in a second database that indicates the individual in the group is assigned to a corresponding item.

2. The apparatus of claim 1, further comprising a third database stored in the memory and including item-assignment criteria for each individual in the group of individuals.

3. The apparatus of claim 2, wherein the item assignment determination application is further configured to match the item-identifying data in the first database to the item assignment-criteria in the third database to determine the individual from the group of individuals to assign to one or more of the items in the transaction.

4. The apparatus of claim 2, wherein the item-assignment criteria is received in the third database by inputs provided from one or more individuals from the group.

5. The apparatus of claim 2, further comprising an item-assignment criteria learning application stored in the memory, executable by the processor and configured to learn the item-assignment criteria based on previous item assignments.

6. The apparatus of claim 1, further comprising a financial management application stored in the memory, executable by the processor and configured to provide item-level filtering for individuals in the group, wherein the filtering is configured to provide a view of which items in the transactions are assigned to which individuals in the group.

7. The apparatus of claim 6, wherein the financial management application is further configured to provide for users to re-assign items that are identified by the users as having been incorrectly assigned to individuals by the item assignment determination application.

8. The apparatus of claim 6, further comprising the group determination application is further configured to match financial account data associated with the transaction to group data stored in a third database that associates financial accounts with groups.

9. The apparatus of claim 1, wherein the aggregation and structuring application is further configured to receive e-receipts corresponding to a transaction, wherein the e-receipts include one or more unique identifiers each of which identify an item in a corresponding transaction.

10. The apparatus of claim 9, wherein the aggregation and structuring is further configured to crawl an email accounts to identify and collect e-receipts.

11. A method for identifying which items in a transaction are associated with which individuals from a group, the method comprising:
receiving, by a computing device processor, transaction item-identifying data in an unstructured format, wherein the transaction item-identifying data is associated with transactions that include one or more items;
structuring, by a computing device processor, the transaction item-identifying data for financial institution system compatibility;
determining, by a computing device processor, that one or more of the transactions are associated with a group of individuals;
determining, by a computing device processor, an individual, from the group of individuals, to assign to one or more of the items in the transactions; and
generating, by a computing device processor, and storing, in computing device memory, an item assignment indicator that indicates the individual from the group is assigned to a corresponding item.

12. The method of claim 11, further comprising providing, in computing device memory, for an item-assignment database that stores item-assignment criteria that indicates which items and types of items are to be assigned to which individuals in the group.

13. The method of claim 12, wherein determining the individual further comprises matching the item-identifying data to the item-assignment criteria to determine the individual from the group of individuals to assign to one or more of the items in the transaction.

14. The method of claim 12, further comprising receiving, at the item-assignment database, item-assignment criteria inputs from one or more individuals in the group, wherein the inputs define the item-assignment criteria.

15. The method of claim 12, further comprising learning, by a computing device processor, the item-assignment criteria based on previous item assignments and storing the learned item-assignment criteria in the item-assignment database.

16. The method of claim 11, further comprising providing, by a computing device processor, within a network-accessible financial management application, item-level filtering for individuals in the group, wherein the filtering is configured to provide a view of which items in the transactions are assigned to which individuals in the group.

17. The method of claim 11, wherein receiving the transaction item-identifying data further comprises receiving e-receipts corresponding to a transaction, wherein the e-receipts include one or more unique identifiers each of which identify an item in the transaction.

18. The method of claim 17, further comprising crawling, by a computing device processor, an email account to identify and collect e-receipts.

19. A computer program product comprising:
a non-transitory computer-readable medium comprising:
a first set of codes for causing a computer to receive transaction item-identifying data in an unstructured format, wherein the transaction item-identifying data is associated with a transaction including one or more items;
a second set of codes for causing a computer to structure the transaction item-identifying data for financial institution system compatibility;
a third set of codes for causing a computer to determine that one or more of the transactions are associated with a group of individuals;
a fourth set of codes for causing a computer to determine an individual, from the group of individuals, to assign to one or more of the items in the transactions; and
a fifth set of codes for causing a computer to generate and store in memory an item assignment indicator that indicates the individual from the group is assigned to a corresponding item.

20. The computer program product of claim 19, further comprising a sixth set of codes for causing a computer to provide for an item-assignment database that stores item-assignment criteria that indicates which items and types of items are to be assigned to which individuals in the group.

21. The computer program product of claim 20, wherein the third set of codes is further configured to match the item-identifying data to the item-assignment criteria to determine the individual from the group of individuals to assign to one or more of the items in the transaction.

22. The computer program product of claim 21, further comprising a seventh set of codes configured to cause a computer to receive, at the item-assignment database, item-assignment criteria inputs from one or more individuals in the group, wherein the inputs define the item-assignment criteria.

23. The computer program product of claim 21, further comprising a seventh set of codes configured to cause a computer to learn the item-assignment criteria based on previous item assignments and storing the learned item-assignment criteria in the item-assignment database.

24. The computer program product of claim 19, further comprising a sixth set of codes for causing a computer to provide, within a network-accessible financial management application, item-level filtering for individuals in the group, wherein the filtering is configured to provide a view of which items in the transactions are assigned to which individuals in the group.

25. The computer program product of claim 19, wherein the first set of codes is further configured to cause the computer to receive e-receipts corresponding to a transaction, wherein the e-receipts include one or more unique identifiers each of which identify an item in the transaction.

26. The computer program product of claim 25, further wherein the first set of codes is further configured to crawl an email account to identify and collect e-receipts.
